(19) United States
(12) Patent Application Publication
(10) Pub. No.: US 2014/0311764 A1
(43) Pub. Date: Oct. 23, 2014

(54) PNEUMATIC TOOL

(71) Applicant: Basso Industry Corp., Taichung (TW)

(72) Inventor: Yi-Ko LIN, Taichung (TW)

(73) Assignee: Basso Industry Corp., Taichung (TW)

(21) Appl. No.: 14/253,859

(22) Filed: Apr. 15, 2014

(30) Foreign Application Priority Data
Apr. 17, 2013 (TW) 102206993

(51) Int. Cl. B25F 5/00

(52) U.S. Cl. CPC B25F 5/00
USPC 173/221

(57) ABSTRACT

A pneumatic tool includes a main body, a power mechanism, a slave valve, a master control lever and a connecting element. The main body includes a front housing and a back housing. The front housing includes a first accommodating space and is connected with the back housing. The power mechanism is disposed in the first accommodating space. The slave valve is coaxially connected with the power mechanism. The master control lever is disposed at the back housing and includes a first protruding portion and a second protruding portion. The first protruding portion protrudes from a side of the back housing. The second protruding portion opposes to the first protruding portion and protrudes from another side of the back housing. The connecting element is disposed between the master control lever and the slave valve, whereby the slave valve is rotated by a linear motion of the master control lever.

### RELATED APPLICATIONS

This application claims priority to Taiwan Application Serial Number 102206993, filed Apr. 17, 2013, which is herein incorporated by reference.

### BACKGROUND

1. Technical Field

The present disclosure relates to a pneumatic tool. More particularly, the present disclosure relates to a pneumatic tool which can be easily switched.

2. Description of Related Art

A pneumatic tool is a tool driven by pressurized air for screwing or drilling, such as a pneumatic drill or a pneumatic wrench. A forward air channel, a reverse air channel, a reversible valve and a power mechanism are disposed inside the pneumatic tool. When a gas port of the reversible valve is communicated with the forward air channel, the pressurized air can flow through the reversible valve and into the forward air channel and the power mechanism, and the pneumatic tool can be driven to rotate in a forward direction. In similar fashion, when the gas port of the reversible valve is communicated with the reverse air channel, the pressurized gas can flow through the reversible valve and into the reverse air channel and the power mechanism, and the pneumatic tool can be driven to rotate in a reverse direction. A conventional pneumatic tool is provided with a switch device connected with the reversible valve. The switch device that is in an arc motion rotates the reversible valve, and thus controls the forward/reverse rotating direction of the pneumatic tool or a flow rate of a gas.

FIG. 1 is a three-dimensional view of a conventional straight pneumatic tool 900. The straight pneumatic tool 900 includes a main body 910, an actuating portion 920, a first handle 930, a second handle 940 and a switch device 950. The first handle 930 and the second handle 940 are substantially annular for allowing a user to grip or hold the straight pneumatic tool 900. The first handle 930 is located at a side of the straight pneumatic tool 900, and the second handle 940 is located at a rear end of the straight pneumatic tool 900. A power mechanism (not shown) and a reversible valve (not shown) are disposed inside the main body 910. The switch device 950 is connected with the reversible valve. When the user toggles the switch device 950, the switch device 950 moves in an arc motion and rotates the eversible valve so as to control a forward/reverse rotating direction of the straight pneumatic tool 900 or a gas flow rate.

However, when the user grips both the first handle 930 and the second handle 940 with two hands thereof, due to the position of the switch device 950, the user cannot toggle the switch device 950 with the hand that grips the second handle 940. In other words, the user has to grip the straight pneumatic tool 900 with only one hand, and toggles the switch device 950 with the other hand for controlling the rotating direction of the straight pneumatic tool 900 or the flow rate of the gas. As a result, it is inconvenient to operate the straight pneumatic tool 900. Moreover, there exist risks of safety and health for the user in operation. For example, after working for a long time, the user may be subject to fatigue and become hardly to bear the weight of straight pneumatic tool 900 with only one hand. The hand of the user griping the handle may be harmed due to the excessive use. The straight pneumatic tool 900 may even fall onto and badly injure a foot of the user.

Given the above, the relevant industry is in need of a pneumatic tool which can be easily switched, i.e., the user can control a rotating direction of the pneumatic tool or a flow rate of a gas with the hand that grips the pneumatic tool, and the aforementioned drawbacks of the straight pneumatic tool 900 can be avoided.

### SUMMARY

According to one aspect of the present disclosure, a pneumatic tool includes a main body, a power mechanism, a slave valve, a master control lever and a connecting element. The main body includes a front housing and a back housing. The front housing includes a first accommodating space. The back housing is connected with the front housing. The power mechanism is disposed in the first accommodating space. The slave valve is coaxially connected with the power mechanism. The master control lever is disposed at the back housing and includes a first protruding portion and a second protruding portion. The first protruding portion protrudes from a side of the back housing. The second protruding portion opposes to the first protruding portion and protrudes from another side of the back housing. The connecting element is disposed between the master control lever and the slave valve, whereby the slave valve is rotated by a linear motion of the master control lever.

According to another aspect of the present disclosure, a pneumatic tool includes a main body, a power mechanism, a slave valve and a master control lever. The main body includes a front housing and a back housing. The front housing includes a first, accommodating space. The back housing is connected with the front housing, and the back housing includes a second accommodating space. The power mechanism is disposed in the first accommodating space. The slave valve is disposed in the second accommodating space and coaxially connected with the power mechanism. The slave valve includes a second tooth portion. The master control lever is disposed at the back housing. The master control lever includes a first protruding portion, a second protruding portion and a third tooth portion. The first protruding portion protrudes from a side of the back housing. The second protruding portion opposes to the first protruding portion and protrudes from another side of the back housing. The third tooth portion is for directly engaging with the second tooth portion of the slave valve, whereby the slave valve is rotated by a linear motion of the master control lever.

### BRIEF DESCRIPTION OF THE DRAWINGS

The disclosure can be more fully understood by reading the following detailed description of the embodiment, with reference made to the accompanying drawings as follows:

FIG. 1 is a three-dimensional view of a conventional straight pneumatic tool;

FIG. 2 is a three-dimensional view of a pneumatic tool according to one embodiment of the present disclosure;

FIG. 3 is an exploded view of the pneumatic tool shown in FIG. 2;

FIG. 4A shows a first position of a master control lever of the pneumatic tool shown in FIG. 2;

FIG. 4B is schematic view showing a relationship of the master control lever, a connecting element and a slave valve of the pneumatic tool shown in FIG. 4A;

FIG. 4C is schematic view showing an air path of the pneumatic tool shown in FIG. 4A;

FIG. 5A shows a second position of the master control lever of the pneumatic tool shown in FIG. 2;

FIG. 5B is schematic view showing a relationship of the master control lever, the connecting element and the slave valve of the pneumatic tool shown in FIG. 5A;

FIG. 5C is schematic view showing an air path of the pneumatic tool shown in FIG. 5A;

FIG. 6A shows a third position of the master control lever of the pneumatic tool shown in FIG. 2;

FIG. 6B is schematic view showing a relationship of the master control lever, the connecting element and the slave valve of the pneumatic tool shown in FIG. 6A;

FIG. 6C is schematic view showing an air path of the pneumatic tool shown in FIG. 6A;

FIG. 7A shows a fourth position of the master control lever of the pneumatic tool shown in FIG. 2;

FIG. 7B is schematic view showing a relationship of the master control lever, the connecting element and the slave valve of the pneumatic tool shown in FIG. 7A;

FIG. 7C is schematic view showing are air path of the pneumatic tool shown in FIG. 7A;

FIG. 8 is a three-dimensional view of a pneumatic tool according to another embodiment of the present disclosure;

FIG. 9 is a three-dimensional view of a pneumatic tool according to further another embodiment of the present disclosure;

FIG. 10 is a three-dimensional view of a pneumatic tool according to yet another embodiment of the present disclosure; and

FIG. 11 is a schematic view showing a relationship of a master control lever and a slave valve of a pneumatic tool according to yet another embodiment of the present disclosure.

### DETAILED DESCRIPTION

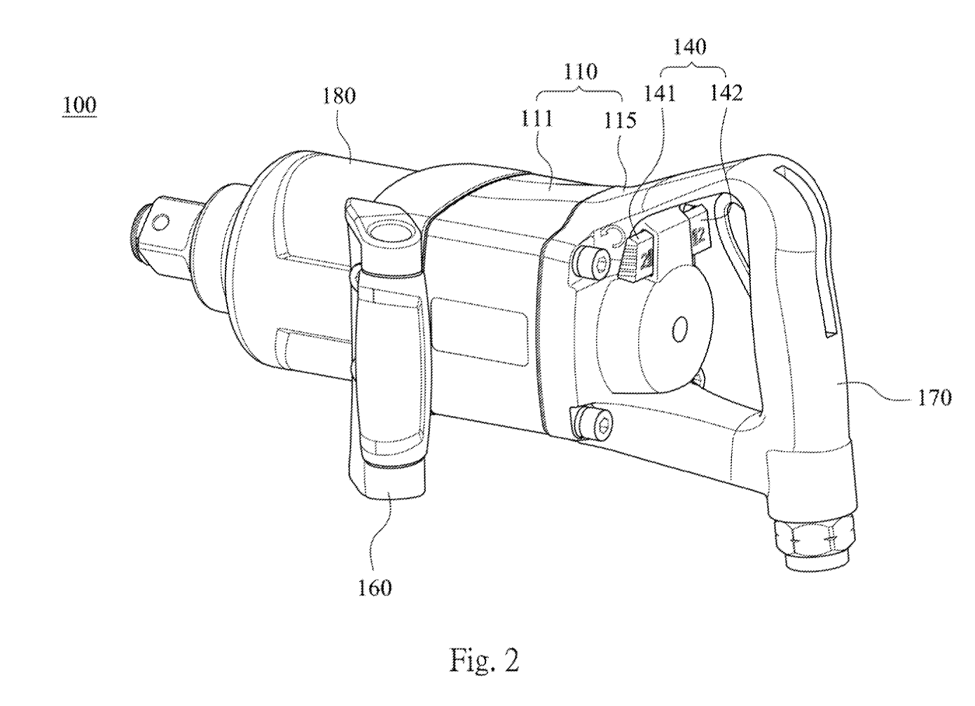

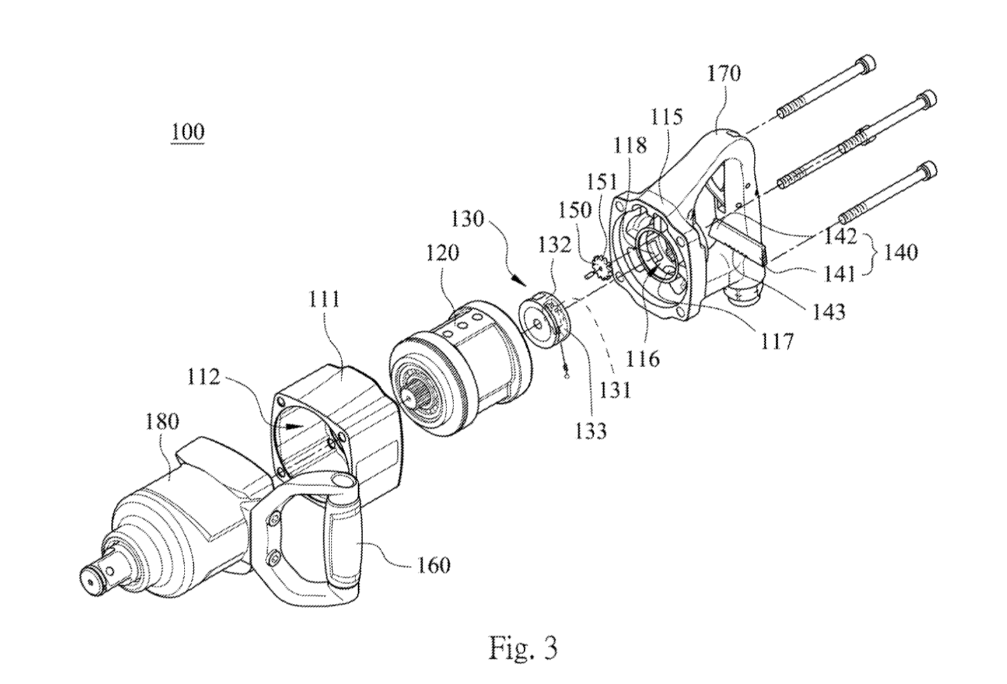

FIG. 2 is a three-dimensional view of a pneumatic tool 100 according to one embodiment of the present disclosure. FIG. 3 is an exploded vie of the pneumatic tool 100 shown in FIG. 2.

The pneumatic tool 100 is a straight pneumatic tool. The pneumatic tool 100 includes an actuating portion 180, a first handle portion 160, a main body 110, a power mechanism 120, a slave valve 130, a connecting element 150, a master control lever 140 and a second handle portion 170.

The main body 110 includes a front housing 111 and a back housing 115. The front housing 111 is connected with the back housing 115. The front housing 111 includes a first accommodating space 112. The power mechanism 120 is disposed in the first accommodating space 112. The power mechanism 120 can be a motor. The back housing 115 includes a second accommodating space 116, a gas inlet 117, a first gas outlet 119 (shown in 4C) and a second gas outlet 118. The first gas outlet 119 and the second gas outlet 118 are symmetrically disposed at the back housing 115, and the gas inlet 117 is located at a symmetrical center of the first gas outlet 119 and the second gas outlet 118.

The slave valve 130 is disposed in the second accommodating space 116 of the back housing 115, and is coaxially connected with the power mechanism 120. The slave valve 130 has a partition element 132 therein, and the interior of the slave valve 130 is divided into three fan-shaped spaces 133 by the partition element 132. Furthermore, the slave valve 130 includes a second tooth portion 131 (shown in 48), and the second tooth portion 131 is located at an end of the slave valve 130 which is farther from the power mechanism 120.

The master control lever 140 is disposed at the back housing 115. The master control lever 140 includes a first protruding portion 141, a second protruding portion 142 and a third tooth portion 143. The first protruding portion 141 protrudes from a side of the back housing 115. The second protruding portion 142 opposes to the first protruding portion 141 and protrudes from another side of the back housing 115. The third tooth portion 143 is located at an end of the master control lever 140 which is closer to the slave valve 130, and is located between the first protruding portion 141 and the second protruding portion 142. In the embodiment, the master control lever 140 is straight. In other embodiment, the master control lever 140 can be substantially straight, for an example, the master control lever 140 can be slightly arc-shaped according to ergonomic operation or appearance design.

The connecting element 150 is disposed between the master control lever 140 and the slave valve 130. In the embodiment, the connecting element 150 is a gear having a first tooth portion 151. The first tooth portion 151 engages with the second tooth portion 131 of the slave valve 130 and the third tooth portion 143 of the master control lever 140 respectively. The slave valve 130 is rotated by a linear motion of the master control lever 140 via the connecting element 150. The relationship between the connecting element 150, the master control lever 140 and the slave valve 130 is not limited to that in the embodiment. In other embodiments, the connecting element 150 can be integrated with the master control lever 140, or the connecting element 150 can be integrated with the slave valve 130. In other words, one of the master control lever 140 and the slave valve 130 has the connecting element 150, so that the master control lever 140 and the slave valve 130 can directly engage with each other. Accordingly, the number of components can be reduced (without the connecting element 150 which is independent and detachable), end the complexity of assembling the pneumatic tool 100 is reduced, too.

The first handle portion 160 is disposed at one side of the pneumatic tool 100. The second handle portion 170 is connected with the back housing 115, wherein the second handle portion 170 extends along an extending direction of the main body 110, and the front housing 111, the back housing 115 and the second handle portion 170 are substantially coaxial. Furthermore, the second handle portion 170 is U-shaped. Therefore, it is favorable for the user to grip or hold the pneumatic tool 100.

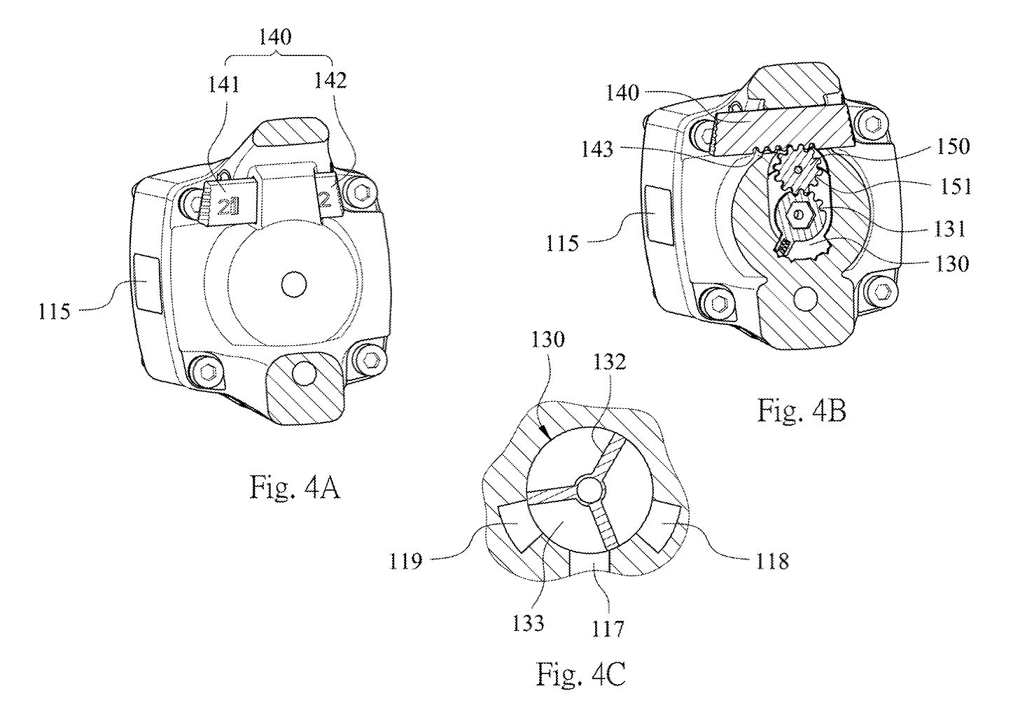

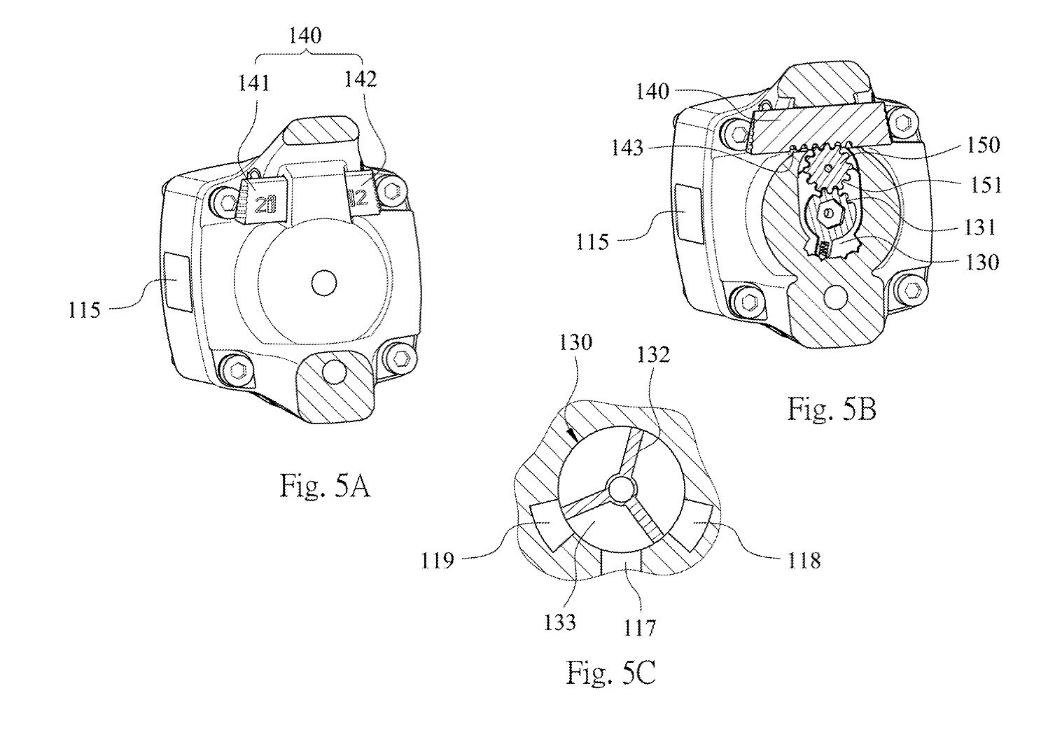

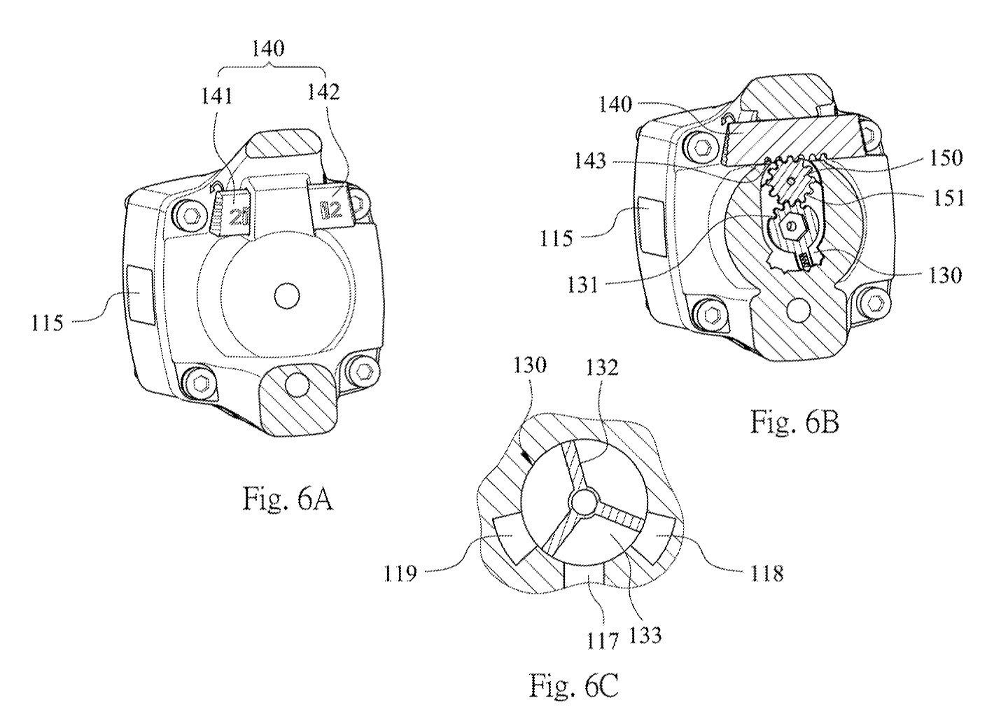

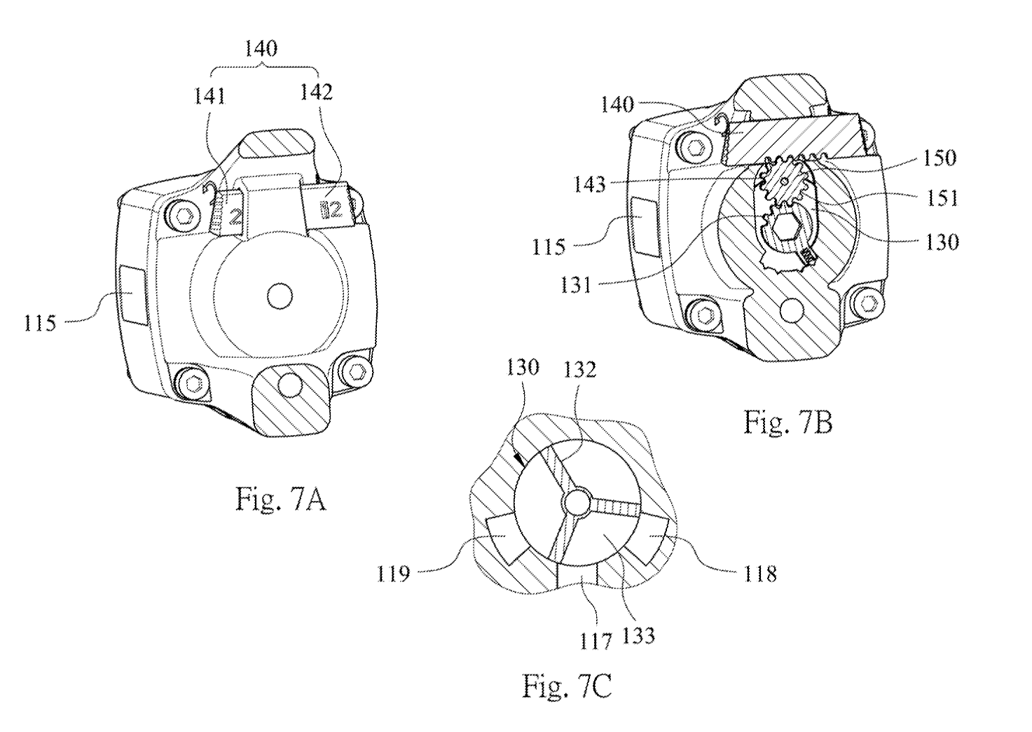

In the embodiment, the user can push the master control lever 140 along an extending direction thereof, so that a linear motion of the master control lever 140 is caused. The slave valve 130 is rotated by the linear motion of the master control lever 140, and a rotation direction (front direction or reverse direction) of the pneumatic tool 100 or a flow rate of a gas is controlled thereby. How to control the rotation direction (front direction or reverse direction) of the pneumatic tool 100 or the flow rate of the gas via pushing the master control lever 140 is described in detail as follows. FIG. 4A, FIG. 5A, FIG. 6A and FIG. 7A respectively show a first position, a second position, a third position and a fourth position of the master control lever 140 of the pneumatic tool 100 shown in FIG. 2. When the master control lever 140 is located at the first position shown in FIG. 4A or the second position shown in FIG. 5A, the pneumatic tool 100 is in the first rotation direction, and the flow rate of the gas in FIG. 4A is different from that in FIG. 5A. When the master control lever 140 is located at the third position shown in FIG. 6A or the fourth position shown in FIG. 7A, the pneumatic tool 100 is in the second rotation direction, and the flow rate of the gas in FIG. 6A is different from that in FIG. 7A.

FIG. 4B, FIG. 5B, FIG. 6B and FIG. 7B are schematic views respectively showing the relationships of the master control lever 140, the connecting element 150 and the slave valve 130 of the pneumatic tool 100 shown in FIG. 4A, FIG. 5A, FIG. 6A and FIG. 7A. As shown in FIG. 4B, FIG. 5B, FIG. 6B and FIG. 7B, the first tooth portion 151 engages with the second tooth portion 131 and the third tooth portion 143 respectively, so that the connecting element 150 is rotated by the linear motion of the master control lever 140 caused by pushing the master control lever 140, and the slave valve 130 is rotated by the connecting element 150. In other words, the slave valve 130 is indirectly rotated by the linear motion of the master control lever 140.

FIG. 4C, FIG. 5C, FIG. 6C and FIG. 7C are schematic views respectively showing air paths of the pneumatic tool 100 shown in FIG. 4A, FIG. 5A, FIG. 6A and FIG. 7A. Please refer to FIG. 3 at the same time. When the slave valve 130 is rotated by the linear motion of the master control lever 140, communication state between the gas inlet 117, the first gas outlet 119 and the second gas outlet 118 is controlled. In FIG. 4C and FIG. 5C, the gas inlet 117 is communicated with the first gas outlet 119. In FIG. 6C and FIG. 7C, the gas inlet 117 is communicated with the second gas outlet 118. Specifically, when the master control lever 140 is located at the first position (as shown in FIG. 4A), a flow path of a gas is as follows. As shown in 4C, the gas flows into the fan-shaped space 133 of the slave valve 130 from the gas inlet 117, then the gas flows through the first gas outlet 119 and then into the power mechanism 120, which enables the actuating portion 180 to rotate in the first rotation direction (the front direction or the reverse direction), In FIG. 5C, when the master control lever 140 is located at the second position (as shown in FIG. 5A), a communicating cross-sectional area between the first gas outlet 119 and the fan-shaped space 133 is decreased in compare with FIG. 4C, so that the flow rate of the gas flowing into the power mechanism 120 can be changed. When the master control lever 140 is located at the third position (as shown in FIG. 6A), a flow path of the gas is as follows. As shown in 6C, the gas flows into the fan-shaped space 133 of the slave valve 130 from the gas inlet 117, then the gas flows through the second gas outlet 118 and then into the power mechanism 120, which enables the actuating portion 180 to rotate in the second rotation direction. In FIG. 7C, when the master control lever 140 is located at the fourth position (as shown in FIG. 7A), the communicating cross-sectional area between the second gas outlet 118 and the fan-shaped space 133 is increased in compare with FIG. 6C, so that the flow rate of the gas flowing into the power mechanism 120 can be changed. Furthermore, the first direction is opposite to the second direction. Specifically, when the first direction is the front direction, the second direction is the reverse direction. Alternatively, when the first direction is the reverse direction, the second direction is the front direction.

According the above description, the pneumatic tool 100 according to the present disclosure has advantages as follows. First, the slave valve 130 is rotated by the linear motion of the master control lever 140 via the connecting element 150, i.e., the rotation direction of the pneumatic tool 100 or the flow rate of the gas can be controlled by simply pushing the master control lever 140. Therefore, the pneumatic tool 100 can be easily switched. Second, due to the engagement of the first tooth portion 151, the second tooth portion 131 and the third tooth portion 143, a contacting area between the master control lever 140 and the connecting element 150 and a contacting area between the connecting element 150 and the slave valve 130 can be reduced. Therefore, the friction force between the master control lever 140 and the connecting element 150 and the friction force between the connecting element 150 and the slave valve 130 can be reduced. As a result, the force that is required for pushing the master control lever 140 so as to cause the linear motion can be saved. Third, the master control lever 140 is close to the second handle portion 170, so that the user can push the master control lever 140 with the hand that holds the second handle portion 170. That means the user can push the master control lever 140 without the help of the other hand that holds the first handle portion 160. Therefore, the fluency of work can be improved, and the work efficiency can be enhanced. Furthermore, the danger generated by holding the pneumatic tool 100 with only one hand can be avoided.

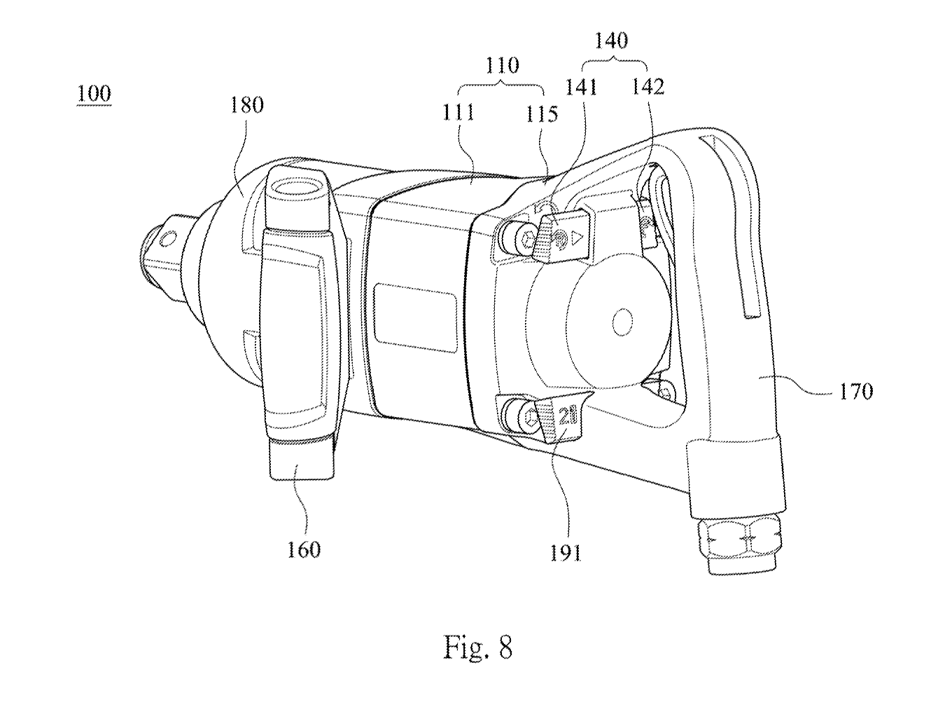

FIG. 8 is a three-dimensional view of a pneumatic tool 100 according to another embodiment of the present disclosure. In the embodiment, a master control lever 140 is only for controlling a rotation direction of the pneumatic tool 100. A user can push the master control lever 140 so as to cause a linear motion, which controls the rotation direction of the pneumatic tool 100. The pneumatic tool 100 further includes an adjustment lever 191 for adjusting a flow rate of a gas. The master control lever 140 and the adjustment lever 191 are disposed close to second handle portion 170, so that the user can push the master control lever 140 car the adjustment lever 191 with the hand that holds the second handle portion 170. That means the user can push the master control lever 140 or the adjustment lever 191 without the help of the other hand that holds the first handle portion 160, Therefore, the fluency of work can be improved, and the work efficiency can be enhanced. Furthermore, the danger generated by holding the pneumatic tool 100 with only one hand can be avoided.

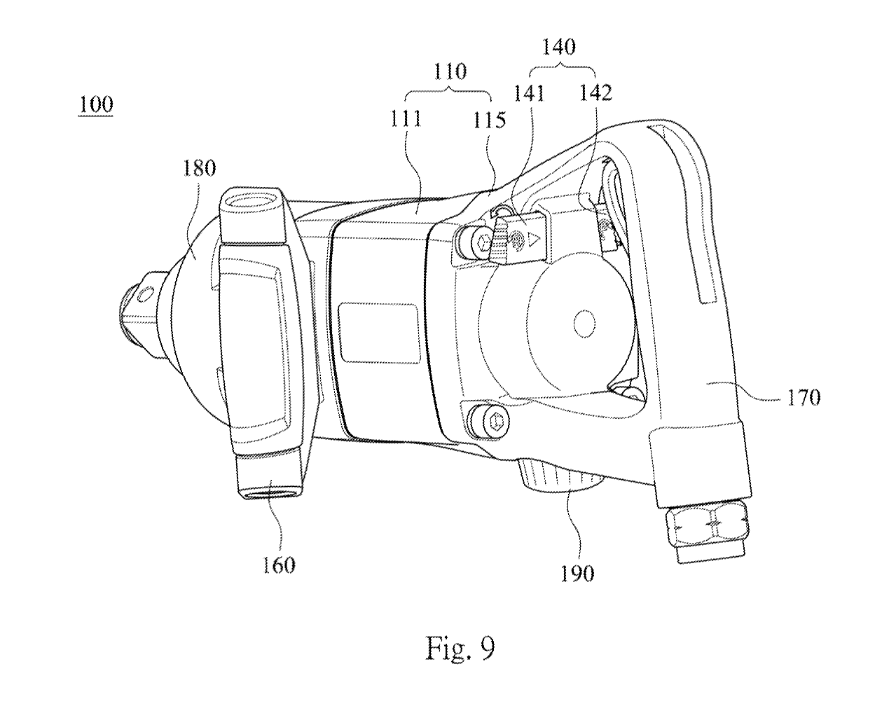

FIG. 9 is a three-dimensional view of a pneumatic tool 100 according to further another embodiment of the present disclosure. In the embodiment, a master control lever 140 is only for controlling a rotation direction of the pneumatic tool 100. A user can push the master control lever 140 so as to cause a linear motion, which controls the rotation direction of the pneumatic tool 100. The pneumatic tool 100 further includes an adjustment knob 190 for adjusting a flow rate of a gas. The master control lever 140 is disposed close to second handle portion 170, so that the user can push the master control lever 140 with the hand that holds the second handle portion 170. That means the user can push the master control lever 140 without the help of the other hand that holds the first handle portion 160. Therefore the fluency of work can be improved, and the work efficiency can be enhanced. Furthermore, the danger generated by holding the pneumatic tool 100 with only one hand can be avoided.

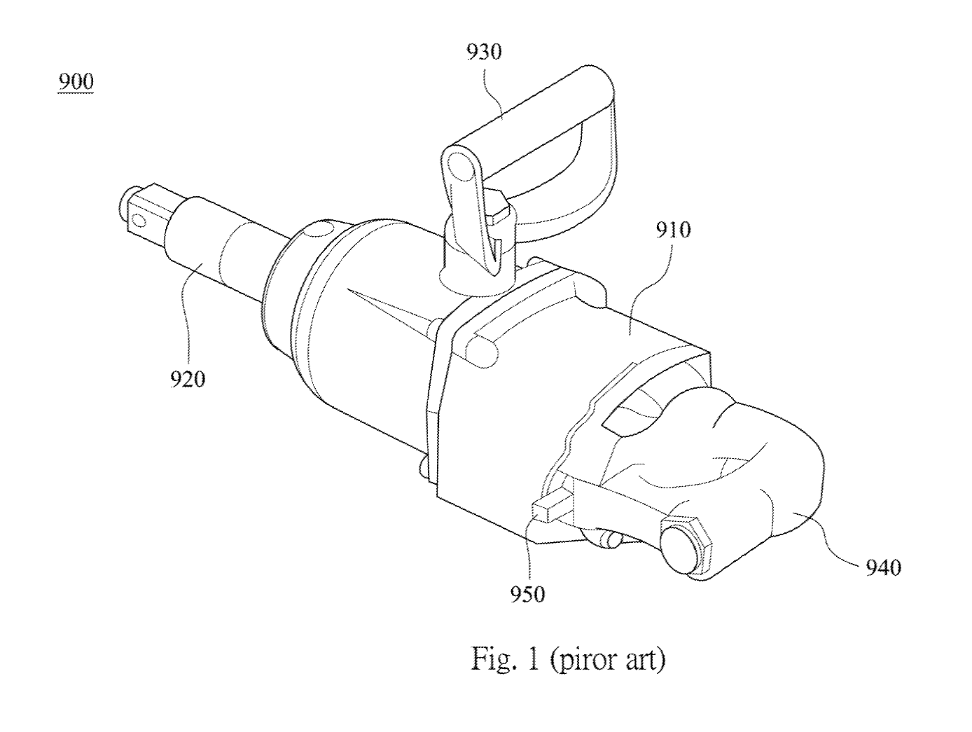

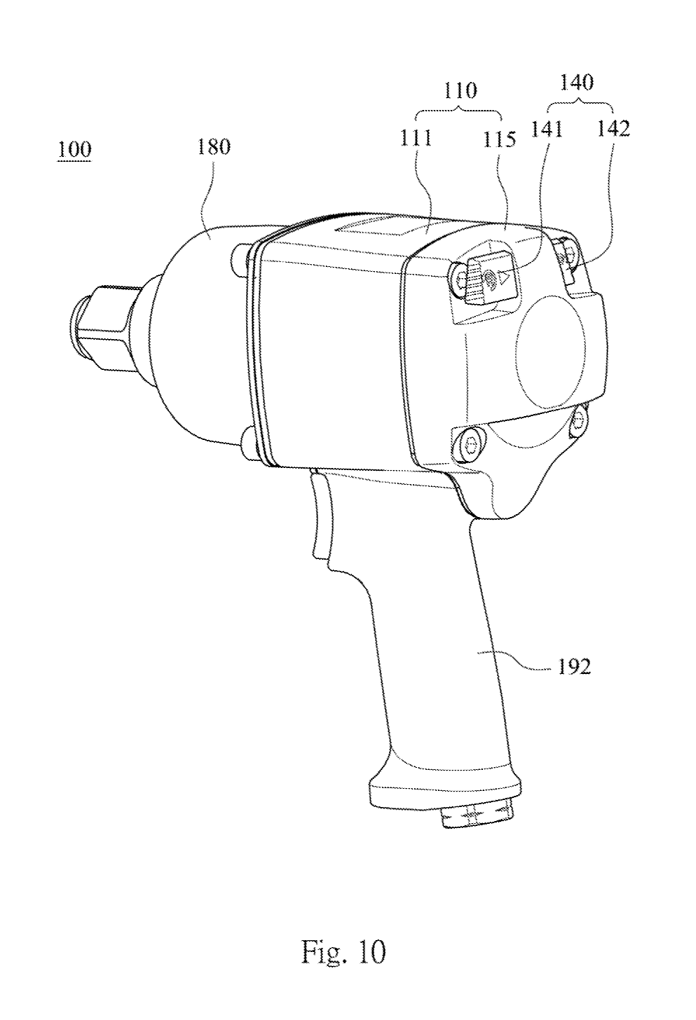

FIG. 10 is a three-dimensional view of a pneumatic tool 100 according to yet another embodiment of the present disclosure. In the embodiment, a handle portion 192 is connected with a front housing 111, and the handle portion 192 is substantially perpendicular to an extending direction of a main body 110. A master control lever 140 is for controlling a rotation direction of the pneumatic tool 100 or a flow rate of a gas. The rotation direction of the pneumatic tool 100 or the flow rate of the gas can be controlled by simply pushing the master control lever 140. Therefore, the pneumatic tool 100 can be switched easily. Furthermore, the master control lever 140, a connecting element (not shown) and a slave valve (not shown) cart be the same as that of the pneumatic tool 100 shown in FIG. 1. The master control lever 140 is disposed at the back housing 115. A first protruding portion 141 protrudes from a side of the back housing 115. The second protruding portion 142 opposes to the first protruding portion 141 and protrudes from another side of the back housing 115. The first tooth portion (not shown) engages with the second tooth portion (not shown) and the third tooth portion (not shown) respectively. A contacting area between the master control lever 140 and the connecting element and a contacting area between the connecting element and the slave valve can be reduced. Therefore, the friction force between the master control lever 140 and the connecting element and the friction force between the connecting element and the slave valve can be reduced. As a result, the force that is required for pushing the master control lever 140 so as to cause the linear motion can be saved.

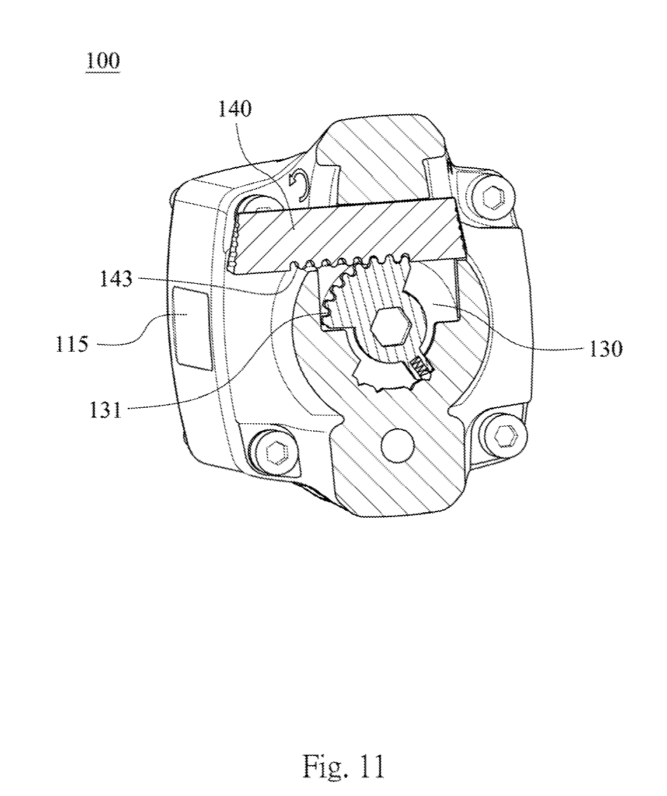

FIG. 11 is a schematic view showing a relationship of a master control lever 140 and a slave valve 130 of a pneumatic tool 100 according to yet another embodiment of the present disclosure. In the embodiment, the master control lever 140 directly engages with the slave valve 130. Specifically, the slave valve 130 includes a second tooth portion 131, and the second tooth portion 131 is located at an end of the slave valve 130. The master control lever 140 includes a third tooth portion 143, and the third tooth portion 143 is located at an end of the master control lever 140 which is closer to the slave valve 130. The third tooth portion 143 directly engages with the second tooth portion 131. Therefore, the slave valve 130 can be rotated by a linear motion of the master control lever 140 via the engagement of the third tooth portion 143 and the second tooth portion 131, so that the rotation direction of the pneumatic tool 100 can be controlled. The direct engagement of the third tooth portion 143 and the second tooth portion 131 has advantages as follows. First, the number of components can be reduced (without an independent and detachable element, such as the aforementioned connecting element 150), and the complexity of assembling the pneumatic tool 100 is reduced, too, Second, a contacting area between the master control lever 140 and the slave valve 130 can be reduced. Therefore, the friction force between the master control lever 140 and the slave valve 130 can be reduced. As a result, the force that is required for pushing the master control lever 140 so as to cause the linear motion can be saved,

Although the present disclosure has been described in considerable detail with reference to certain embodiments thereof, other embodiments are possible. Therefore, the spirit and scope of the appended claims should not be limited to the description of the embodiments contained herein.

it will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A pneumatic tool, comprising:
a main body, comprising:
a front housing comprising a first accommodating space; and
a back housing connected with the front housing;
a power mechanism disposed in the first accommodating space;
a slave valve coaxially connected with the power mechanism;
a master control lever disposed at the back housing, the master control lever comprising:
a first protruding portion protruding from a side of the back housing; and
a second protruding portion opposing to the first protruding portion, wherein the second protruding portion protrudes from another side of the back housing; and
a connecting element disposed between the master control lever and the slave valve, whereby the slave valve is rotated by a linear motion of the master control lever.

2. The pneumatic tool of claim 1, wherein the back housing comprises a second accommodating space, and the slave valve is disposed in the second accommodating space.

3. The pneumatic tool of claim 1, further comprising:
a handle portion connected with the back housing, wherein the handle portion is U-shaped and extends along an extending direction of the main body, and the front housing, the back housing and the handle portion are substantially coaxial.

4. The pneumatic tool of claim 1, further comprising:
a handle portion connected with the front housing, wherein the handle portion is substantially perpendicular to an extending direction of the main body.

5. The pneumatic tool of claim 1, wherein the connecting element is integrated with the master control lever or the slave valve.

6. The pneumatic tool of claim 5, wherein the connecting element is integrated with the master control lever, the connecting element comprises a first tooth portion, the lave valve comprises a second tooth portion, and the first tooth portion engages with the second tooth portion.

7. The pneumatic tool of claim 5, wherein the connecting element is integrated with the slave valve, the connecting element comprises a first tooth portion, the master control lever further comprises a third tooth portion, and the third tooth portion engages with the first tooth portion.

8. A pneumatic tool, comprising:
a main body, comprising:
a front housing comprising a first accommodating space: and
a back housing connected with the front housing, wherein the back housing comprises a second accommodating space;
a power mechanism disposed in the first accommodating space:
a slave valve disposed in the second accommodating space, wherein the slave valve is coaxially connected with the power mechanism, and the slave valve comprises a second tooth portion; and
a master control lever disposed at the back housing, the master control lever comprising:
a first protruding portion protruding from a side of the back housing;
a second protruding portion opposing to the first protruding portion, wherein the second protruding portion protrudes from another side of the back housing, and
a third tooth portion for directly engaging with the second tooth portion of the slave valve, whereby the slave valve is rotated by a linear motion of the master control lever.

9. The pneumatic tool of claim 8, further comprising:
a handle portion connected with the back housing, wherein the handle portion extends along an extending direction of the main body.

10. The pneumatic tool of claim 8, wherein the master control lever is straight or substantially straight.

11. The pneumatic tool of claim 8, further comprising:
a handle portion connected with the back housing, wherein the handle portion is U-shaped and extends along an extending direction of the main body, and the front housing, the back housing and the handle portion are substantially coaxial.

12. The pneumatic tool of claim 8, further comprising:
a handle portion connected with the front housing, wherein the handle portion is substantially perpendicular to an extending direction of the main body.
